(19) United States
(12) Patent Application Publication
(10) Pub. No.: US 2026/0155463 A1
(43) Pub. Date: Jun. 4, 2026

(54) BATTERY

(71) Applicant: Panasonic Intellectual Property Management Co., Ltd., Osaka (JP)

(72) Inventor: Eiichi KOGA, Hokkaido (JP)

(21) Appl. No.: 19/453,580

(22) Filed: Jan. 20, 2026

Related U.S. Application Data
(63) Continuation of application No. PCT/JP2024/021943, filed on Jun. 17, 2024.

(30) Foreign Application Priority Data
Jul. 21, 2023 (JP) 2023-119502

(51) Int. Cl. H01M 10/42; H01B 1/06; H01M 4/136; H01M 10/0562

(52) U.S. Cl. CPC H01M 10/4235; H01B 1/06; H01M 4/136; H01M 10/0562; H01M 2300/008; H01M 2300/0091; H01M 2300/0094

(57) ABSTRACT

A battery according to the present disclosure includes a first electrode layer, a second electrode layer, and an electrolyte layer. The battery satisfies at least one configuration selected from the group consisting of the following (I) and (II):
(I) at least one selected from the group consisting of the first electrode layer, the second electrode layer, and the electrolyte layer includes at least one titanium-containing material selected from the group consisting of a titanium oxyhalide and a titanium oxide; and
(II) the battery further includes a side surface layer, the side surface layer being disposed on a side surface of at least one layer selected from the group consisting of the first electrode layer, the second electrode layer, and the electrolyte layer, the side surface layer including at least one titanium-containing material selected from the group consisting of a titanium oxyhalide and a titanium oxide.

This application is a continuation of PCT/JP2024/021943 filed on Jun. 17, 2024, which claims foreign priority of Japanese Patent Application No. 2023-119502 filed on Jul. 21, 2023, the entire contents of both of which are incorporated herein by reference.

### BACKGROUND OF THE INVENTION

### 1. Field of the Invention

The present disclosure relates to a battery.

### 2. Description of Related Art

WO 2023/037817 discloses a battery including a solid electrolyte coating an active material, the solid electrolyte including Li, Ti, M, and F, where M is at least one selected from the group consisting of Ca, Mg, Al, Y, and Zr. In WO 2023/037817, the above solid electrolyte is included in a coating layer coating the active material.

### SUMMARY OF THE INVENTION

In conventional techniques, there has been a demand for high-reliability batteries. In view of this, the present disclosure provides a battery having enhanced mechanical strength and thus enhanced reliability.

A battery of the present disclosure includes:
a first electrode layer;
a second electrode layer; and
an electrolyte layer disposed between the first electrode layer and the second electrode layer, wherein
the battery satisfies at least one configuration selected from the group consisting of the following (I) and (II):
   (I) at least one selected from the group consisting of the first electrode layer, the second electrode layer, and the electrolyte layer includes at least one titanium-containing material selected from the group consisting of a titanium oxyhalide and a titanium oxide; and
   (II) the battery further includes a side surface layer, the side surface layer being disposed on a side surface of at least one layer selected from the group consisting of the first electrode layer, the second electrode layer, and the electrolyte layer, the side surface layer including at least one titanium-containing material selected from the group consisting of a titanium oxyhalide and a titanium oxide,
the titanium oxyhalide is represented by the following composition formula (1):

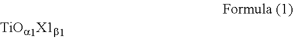

in the composition formula (1), the X1 is at least one selected from the group consisting of F, Cl, Br, and I, the α1 satisfies 0.95≤α1≤1.05, and the β1 satisfies 1.95≤β1≤2.05, and
the titanium oxide is represented by the following composition formula (2):

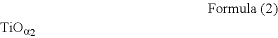

in the composition formula (2), the α2 satisfies 1.95≤α2≤2.05.

The present disclosure can provide a battery having enhanced reliability.

### BRIEF DESCRIPTION OF THE DRAWINGS

FIG. 1 is a cross-sectional view and a plan view schematically showing the configuration of a battery 1000 according to Embodiment 1.

FIG. 2 is a cross-sectional view and a plan view schematically showing the configuration of a battery 1100 according to Embodiment 2.

FIG. 3 is a cross-sectional view and a plan view schematically showing the configuration of a battery 1200 according to Embodiment 3.

FIG. 4 is a cross-sectional view and a plan view schematically showing the configuration of a battery 1300 according to Embodiment 4.

FIG. 5 is a cross-sectional view and a plan view schematically showing the configuration of a battery 1400 according to Embodiment 5.

FIG. 6 is a cross-sectional view and a plan view schematically showing the configuration of a battery 1500 according to Embodiment 6.

### DETAILED DESCRIPTION

Embodiments of the present disclosure are described in detail below with reference to the drawings.

The embodiments described below are each presented as a general or specific example. The numerical values, shapes, materials, arrangement positions and connection manners of constituents, manufacturing steps, the order of the manufacturing steps, and the like indicated in the embodiments below are merely illustrative and should not be construed as limiting the present disclosure. Furthermore, among the constituents in the embodiments below, those not recited in the independent claim representing the broadest concept are described as optional constituents.

In the present specification, terms such as “parallel” representing relationships between constituents, terms such as “rectangular” representing the shapes of constituents, and numerical ranges are not expressions limited to their strict meanings, but are intended to encompass substantial equivalents including, for example, even variations of several percent.

The drawings are schematic diagrams and are not necessarily strictly accurate. Accordingly, for example, the scales and the like in the drawings are not necessarily consistent. In the drawings, substantially identical constituents are denoted by the same reference numerals, and redundant descriptions thereof are omitted or simplified.

In the present specification and the drawings, the x axis, the y axis, and the z axis indicate the three axes in a three-dimensional orthogonal coordinate system. In the embodiments, the z-axis direction is defined as the thickness direction of the battery. Furthermore, in the present specification, the “thickness direction” refers to a direction perpendicular to the plane along which the layers in the battery are stacked, unless specifically stated otherwise.

In the present specification, the term “plan view” means viewing the battery along the stacking direction of the layers in the battery. In the present specification, the “thickness” refers to the length of the battery and the layers in the stacking direction.

In the present specification, for the battery and the layers, the “side surface” refers to the surface extending along the stacking direction of the layers in the battery, and the “principal surface” refers to the surface other than the side surface, unless specifically stated otherwise.

In the present specification, “in” and “out” in the terms “inner”, “outer”, and the like respectively indicate the side closer to the center of the battery and the side closer to the periphery of the battery when the battery is viewed along the stacking direction of the layers in the battery.

In the present specification, the terms “upper” and “lower” in the battery configuration respectively do not mean being in the upward direction (vertically above) and being in the downward direction (vertically below) in absolute spatial reference, but are used as the terms defined by the relative positional relationship based on the stacking order in the stacked structure. Furthermore, the terms “upper” and “lower” are applied not only in the case where two constituents are disposed with a space therebetween and another constituent is present between the two constituents, but also in the case where two constituents are disposed in close and direct contact with each other.

### Embodiment 1

A battery according to Embodiment 1 is described below.

The battery according to Embodiment 1 includes a first electrode layer, a second electrode layer, and an electrolyte layer. The electrolyte layer is disposed between the first electrode layer and the second electrode layer.

The battery according to Embodiment 1 satisfies at least one configuration selected from the group consisting of the following (I) and (II):
(I) at least one selected from the group consisting of the first electrode layer, the second electrode layer, and the electrolyte layer includes at least one titanium-containing material selected from the group consisting of a titanium oxyhalide and a titanium oxide; and
(II) the battery according to Embodiment 1 further includes a side surface layer, the side surface layer being disposed on a side surface of at least one layer selected from the group consisting of the first electrode layer, the second electrode layer, and the electrolyte layer, the side surface layer including at least one titanium-containing material selected from the group consisting of a titanium oxyhalide and a titanium oxide.

The above titanium oxyhalide is represented by the following composition formula (1):

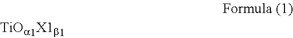

in the above composition formula (1), X1 is at least one selected from the group consisting of F, Cl, Br, and I, α1 satisfies 0.95≤α1≤1.05, and β1 satisfies 1.95≤β1≤2.05.

The above titanium oxide is represented by the following composition formula (2):

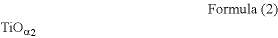

in the composition formula (2), α2 satisfies 1.95≤α2≤2.05.

In the above composition formula (1), α1 may be 1. In the above composition formula (1), β1 may be 2. The above titanium oxyhalide may be represented by TiOX1₂.

In the above composition formula (2), α2 may be 2. That is, the above titanium oxide may be represented by TiO₂.

The above titanium-containing material is relatively hard, and is harder than, for example, the solid electrolyte included in the battery. Accordingly, the battery according to Embodiment 1 including the above titanium-containing material has enhanced mechanical strength, enhancing flexural resistance and impact resistance. Therefore, the battery according to Embodiment 1 can have enhanced mechanical strength and thus enhanced reliability. The amount and location of the above titanium-containing material to be included may be adjusted as appropriate depending on the purpose. Therefore, the battery according to Embodiment 1 can achieve desired reliability.

The above effects can be achieved when the battery according to Embodiment 1 satisfies any of the above configurations (I) and (II). For example, when the above configuration (I) is satisfied, it is possible to enhance the strength of the electrode layer and/or the electrolyte layer, each of which is a power-generating element of the battery. This enhances the reliability of the battery. Furthermore, when the above configuration (II) is satisfied, it is possible to effectively suppress, by the side surface layer including the above titanium-containing material, structural defects that tend to occur at a side surface of the battery serving as an initiation site (i.e., cracking or peeling originating from a side surface) and in which the influence of external impact and thermal shock tends to become apparent. This enhances the reliability of the battery.

In the present specification, the term “titanium-containing material” refers to at least one selected from the group consisting of the titanium oxyhalide represented by the above composition formula (1) and the titanium oxide represented by the above composition formula (2).

A configuration example of the battery according to Embodiment 1 is described below. The configuration example described below is an example in which the battery according to Embodiment 1 satisfies the above configuration (I) and the electrolyte layer is a solid electrolyte layer. That is, the battery in the configuration example described below is, for example, an all-solid-state battery.

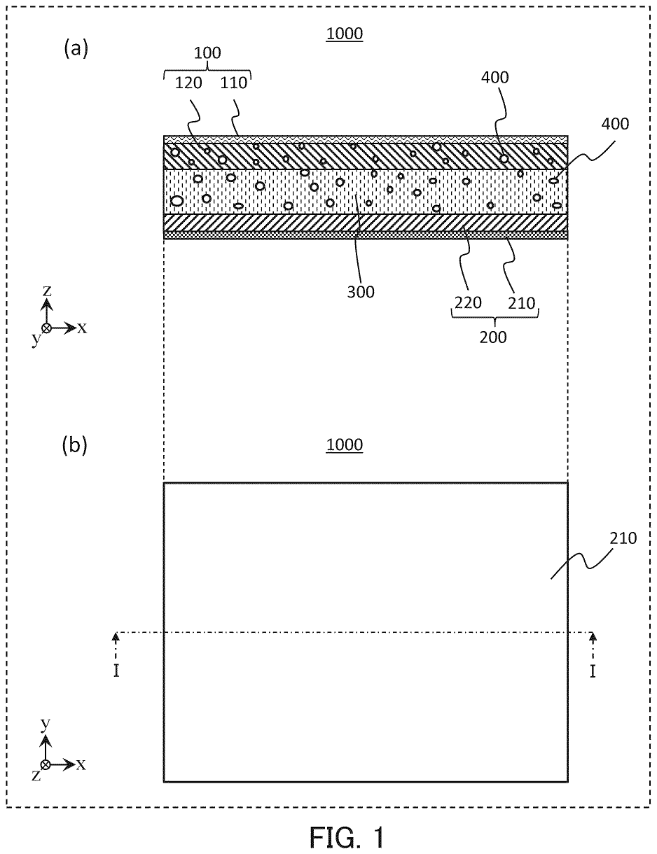

FIG. 1 is a cross-sectional view and a plan view schematically showing the configuration of a battery 1000 according to Embodiment 1.

FIG. 1(a) is a cross-sectional view of the battery 1000 according to Embodiment 1. FIG. 1(b) is a plan view of the battery 1000 according to Embodiment 1 as viewed from below in the z-axis direction. In FIG. 1(a), a cross section at the position indicated by line I-I in FIG. 1(b) is shown.

As shown in FIG. 1, the battery 1000 includes a first electrode layer 100, a second electrode layer 200 disposed parallel to and opposite to the first electrode layer 100, and a solid electrolyte layer 300 positioned between the first electrode layer 100 and the second electrode layer 200. In other words, the battery 1000 is a battery including the first electrode layer 100, the solid electrolyte layer 300, and the second electrode layer 200 in this order in the stacking direction. For example, the first electrode layer 100 and the solid electrolyte layer 300 include a titanium-containing material. The titanium-containing material included may be a particulate titanium-containing material (hereinafter referred to as “titanium-containing material particles”) 400. As described above, the battery 1000 is, for example, an all-solid-state battery.

The first electrode layer 100 includes a first current collector 110 and a first active material layer 120. For example, the first active material layer 120 includes the titanium-containing material particles 400. Furthermore, the second electrode layer 200 includes a second current collector 210 and a second active material layer 220. The solid electrolyte layer 300 includes the titanium-containing material particles 400, is positioned between the first active material layer 120 and the second active material layer 220, and is in contact with both the first active material layer 120 and the second active material layer 220. In the battery 1000 shown in FIG. 1, the titanium-containing material particles 400 are included only in the first electrode layer 100 and the solid electrolyte layer 300. However, the titanium-containing material particles 400 may also be included in the second electrode layer 200.

In the example shown in FIG. 1, the first current collector 110, the first active material layer 120, the solid electrolyte layer 300, the second active material layer 220, and the second current collector 210 each have an approximately rectangular shape in plan view. However, in the battery according to Embodiment 1, the shape of each of these constituents is not limited to a rectangular shape.

Furthermore, in the example shown in FIG. 1, the current collector 110, the first active material layer 120, the solid electrolyte layer 300, the second active material layer 220, and the second current collector 210 have the same size and coincident outlines in plan view; however, the configuration is not limited thereto. For example, the first active material layer 120 may be smaller than the second active material layer 220. The first active material layer 120 and the second active material layer 220 may be smaller than the solid electrolyte layer 300. For example, a portion of the solid electrolyte layer 300 may be in contact with at least one of the first current collector 110 and the second current collector 210.

In the battery 1000 according to Embodiment 1, for example, the first electrode layer 100 is the positive electrode layer, and the second electrode layer 200 is the negative electrode layer. In this case, specifically, the first current collector 110 is the positive electrode current collector, and the first active material layer 120 is the positive electrode active material layer. Furthermore, the second current collector 210 is the negative electrode current collector, and the second active material layer 220 is the negative electrode active material layer.

A configuration may be employed in which the first electrode layer 100 is the negative electrode and the second electrode layer 200 is the positive electrode. Specifically, a configuration may be employed in which the first current collector 110 is the negative electrode current collector and the first active material layer 120 is the negative electrode active material layer. A configuration may be employed in which the second current collector 210 is the positive electrode current collector and the second active material layer 220 is the positive electrode active material layer.

In the following description, the positive electrode active material layer and the negative electrode active material layer may be collectively referred to simply as the “active material layer”. Furthermore, the positive electrode current collector and the negative electrode current collector may be collectively referred to simply as the “current collector”.

### Current Collector

The current collector is formed of a conductive material. Examples of the material of the current collector include stainless steel, nickel (Ni), aluminum (Al), iron (Fe), titanium (Ti), copper (Cu), palladium (Pd), gold (Au), platinum (Pt), and an alloy of two or more of these. As the current collector, foil-shaped, plate-shaped, or mesh-shaped bodies formed of these materials can be used.

The material of the current collector can be selected in view of the manufacturing process, operating temperature, operating pressure, operating potential of the battery to which the current collector is subjected, or conductivity. Furthermore, the material of the current collector can be selected depending also on the tensile strength or heat resistance required for the battery.

The current collector may be a high-strength electrolytic copper foil or a cladding material obtained by laminating dissimilar metal foils.

The current collector has a thickness of, for example, 10 μm or more and 100 μm or less.

The surface of the current collector may be processed into a rough surface having irregularities in order to enhance adhesion to the active material layer.

An adhesive component, such as an organic binder, may be applied to the surface of the current collector. Furthermore, insulating particles, conductive particles, or semiconductive particles may adhere to the surface of the current collector. These configurations strengthen the bonding property at the interface between the current collector and another layer (e.g., the active material layer), enabling enhancements in the mechanical and thermal reliability, cycle characteristics, and the like of the battery 1000.

### Active Material Layer

The first active material layer 120 is, for example, a positive electrode active material layer. The first active material layer 120 is sandwiched between the first current collector 110 and the solid electrolyte layer 300. The first active material layer 120 may be in contact with the principal surface of the first current collector 110. The first active material layer 120 may be in contact with the principal surface of the solid electrolyte layer 300.

The second active material layer 220 is, for example, a negative electrode active material layer. The second active material layer 220 is sandwiched between the second current collector 210 and the solid electrolyte layer 300. The second active material layer 220 may be in contact with the principal surface of the second current collector 210. The second active material layer 220 may be in contact with the principal surface of the solid electrolyte layer 300.

The positive electrode active material layer includes a positive electrode active material.

The positive electrode active material refers to a material that intercalates or deintercalates metal ions, such as lithium (Li) ions or magnesium (Mg) ions, into or from the crystal structure at a higher potential than the potential of the negative electrode and is accordingly oxidized or reduced. The positive electrode active material can be selected as appropriate depending on the battery type, and a known positive electrode active material can be used.

The positive electrode active material is, for example, a compound including lithium and a transition metal element. The compound is, for example, an oxide including lithium and a transition metal element or a phosphate compound including lithium and a transition metal element.

Examples of the oxide including lithium and a transition metal element include a lithium-nickel composite oxide, such as LiNiₓM₁₋ₓO₂ (where M is at least one selected from the group consisting of Co, Al, Mn, V, Cr, Mg, Ca, Ti, Zr, Nb, Mo, and W, and 0<x≤1 is satisfied); a layered oxide, such as lithium cobalt oxide (LiCoO₂) and lithium nickel oxide (LiNiO₂); and a lithium manganese oxide (e.g., LiMn₂O₄, Li₂MnO₃, and LiMnO₂) having a spinel structure.

An example of the phosphate compound including lithium and a transition metal element is lithium iron phosphate (LiFePO₄) having an olivine structure.

As the positive electrode active material, sulfur (S) and a sulfide, such as lithium sulfide (Li₂S), may be used. In this case, particles of the positive electrode active material may be subjected to coating with or addition of lithium niobate (LiNbO₃) or the like.

The positive electrode active material may be only one of these materials or a combination of two or more of these materials.

The positive electrode active material layer may include the titanium-containing material. This enables the titanium-containing material to absorb stress caused by expansion and contraction of the positive electrode active material resulting from external stress or charging and discharging and by thermal expansion and contraction of the positive electrode active material resulting from thermal cycling. Accordingly, the mechanical strength of the positive electrode active material layer can be enhanced, thereby suppressing the occurrence of defects. Furthermore, the compatibility of the positive electrode active material layer with the solid electrolyte layer 300 (e.g., expansion and contraction properties during charging and discharging or expansion and contraction properties during thermal cycling) can be adjusted. As shown in FIG. 1, the titanium-containing material may be the titanium-containing material particles 400.

To enhance lithium-ion conductivity or electronic conductivity, the positive electrode active material layer, which includes the positive electrode active material, may include a material other than the positive electrode active material and the titanium-containing material. That is, the positive electrode active material layer may be a mixture layer. Examples of the material include a solid electrolyte, such as an inorganic solid electrolyte or a sulfide-based solid electrolyte, a conductive additive, such as acetylene black, and a binder, such as polyethylene oxide or polyvinylidene fluoride. The solid electrolyte may be, for example, a halide solid electrolyte. Examples of the halide solid electrolyte included in the positive electrode active material layer are the same as the later-described examples of a halide solid electrolyte included in the solid electrolyte layer 300.

By mixing the positive electrode active material with other additive materials, such as a solid electrolyte, in a predetermined ratio to form the positive electrode active material layer, it is possible to enhance the ionic conductivity in the positive electrode active material layer and to enhance the electronic conductivity in the positive electrode active material layer as well.

The positive electrode active material layer may have a thickness of, for example, 5 μm or more and 300 μm or less.

The negative electrode active material layer includes a negative electrode active material.

The negative electrode active material layer is a layer that is composed primarily of a negative electrode material, such as a negative electrode active material.

The negative electrode active material refers to a material that intercalates or deintercalates metal ions, such as lithium (Li) ions or magnesium (Mg) ions, into or from the crystal structure at a lower potential than the potential of the positive electrode and is accordingly oxidized or reduced. The negative electrode active material can be selected as appropriate depending on the battery type, and a known negative electrode active material can be used.

Examples of the negative electrode active material include a carbon material, such as natural graphite, artificial graphite, a graphite carbon fiber, or resin baked carbon, and an alloy-based material to be mixed with a solid electrolyte. Examples of the alloy-based material include a lithium alloy, such as LiAl, LiZn, Li₃Bi, Li₃Cd, Li₃Sb, Li₄Si, Li_{4.4}Pb, Li_{4.4}Sn, Li_{0.17}C, or LiC₆, an oxide of lithium and a transition metal element, such as lithium titanate (Li₄Ti₅O₁₂), and a metal oxide, such as zinc oxide (ZnO) or silicon oxide (SiOₓ).

The negative electrode active material may be only one of these materials or a combination of two or more of these materials.

To enhance lithium-ion conductivity or electronic conductivity, the negative electrode active material layer, which includes the negative electrode active material, may include a material other than the negative electrode active material. Examples of the material include a solid electrolyte, such as an inorganic solid electrolyte or a sulfide-based solid electrolyte, a conductive additive, such as acetylene black, and a binder, such as polyethylene oxide or polyvinylidene fluoride. The solid electrolyte may be, for example, a halide solid electrolyte. Examples of the halide solid electrolyte included in the negative electrode active material layer are the same as the later-described examples of a halide solid electrolyte included in the solid electrolyte layer 300.

The negative electrode active material layer may have a thickness of, for example, 5 μm or more and 300 μm or less.

The negative electrode active material layer may include the titanium-containing material, as with the positive electrode active material layer described above.

### Solid Electrolyte Layer

The solid electrolyte layer 300 includes a solid electrolyte.

The solid electrolyte layer 300 includes the solid electrolyte, for example, as its main component. Here, the main component refers to the component having the highest mass content in the solid electrolyte layer 300. As described above, the solid electrolyte layer 300 includes, for example, the titanium-containing material. The titanium-containing material is, for example, the titanium-containing material particles 400.

The solid electrolyte should be any known solid electrolyte for batteries that has ionic conductivity. The solid electrolyte included in the solid electrolyte layer 300 can be, for example, a solid electrolyte that conducts metal ions, such as lithium ions or magnesium ions.

The solid electrolyte can be a sulfide solid electrolyte, an oxide solid electrolyte, or a halide solid electrolyte.

Examples of the sulfide solid electrolyte include those based on Li₂S—P₂S₅, Li₂S—SiS₂, Li₂S—B₂S₃, Li₂S—GeS₂, Li₂S—SiS₂—LiI, Li₂S—SiS₂—Li₃PO₄, Li₂S—Ge₂S₂, Li₂S—GeS₂—P₂S₅, and Li₂S—GeS₂—ZnS.

Examples of the oxide solid electrolyte include a lithium-containing metal oxide, a lithium-containing metal nitride, lithium phosphate (Li₃PO₄), and a lithium-containing transition metal oxide. Examples of lithium-containing metal oxides include Li₂O—SiO₂ and Li₂O—SiO₂—P₂O₅. Examples of lithium-containing metal nitrides include LiₓP_{y}O_{1-z}N_{z} (0<z≤1). Examples of lithium-containing transition metal oxides include lithium titanium oxide.

The halide solid electrolyte is, for example, a solid electrolyte including Li, at least one element selected from the group consisting of metalloid elements and metal elements other than Li, and a halogen element.

The “metalloid elements” refer to B, Si, Ge, As, Sb, and Te. The “metal elements” refer to all the elements included in Groups 1 to 12 of the periodic table (except hydrogen) and all the elements included in Groups 13 to 16 of the periodic table (except B, Si, Ge, As, Sb, Te, C, N, P, O, S, and Se).

It is desirable that the halide solid electrolyte be substantially free of sulfur. “The halide solid electrolyte is substantially free of sulfur” means that the halide solid electrolyte does not include sulfur as its constituent element, except for sulfur unavoidably introduced as an impurity. In this case, the sulfur introduced as an impurity into the halide solid electrolyte is, for example, 1 mol % or less. It is more desirable that the halide solid electrolyte be free of sulfur. The sulfur-free solid electrolyte does not generate hydrogen sulfide when exposed to the atmosphere, and is accordingly excellent in safety.

The solid electrolyte layer 300 includes, for example, a halide solid electrolyte. For example, when the titanium-containing material particle 400 includes the titanium oxyhalide, the halide solid electrolyte included in the solid electrolyte layer 300 and the titanium-containing material particle 400 have thermal expansion characteristics that tend to match each other because both are halides. Accordingly, the bonding interface between the titanium-containing material particle 400 and the halide solid electrolyte becomes firm. This suppresses the occurrence of structural defects caused by peeling at the bonding interface between the titanium-containing material particle 400 and the halide solid electrolyte that results from thermal shock or thermal cycling. That is, according to this configuration, the effectiveness of the titanium-containing material against thermal shock and thermal cycling is further enhanced. Consequently, the reliability of the battery 1000 according to Embodiment 1 is further enhanced.

The halide solid electrolyte may include Ti. According to this configuration, the solid electrolyte layer 300 including a solid electrolyte having a high ionic conductivity of, for example, 1 μS/cm or more, can be obtained. Furthermore, owing to the presence of Ti, which is included in both the titanium-containing material and the halide solid electrolyte in common, the titanium-containing material and the solid electrolyte firmly bond to each other, facilitating formation of an integrated bonding interface. Accordingly, when the titanium-containing material is included in the solid electrolyte layer, the titanium-containing material can coexist with the solid electrolyte within the solid electrolyte layer, in a stable manner (e.g., with no formation of fine defects in the surrounding region). Therefore, a battery having further enhanced reliability can be obtained. Furthermore, since the halide solid electrolyte including Ti has atmospheric stability and excellent heat resistance up to about 650° C. to about 700° C., even when TiOF₂, which has a high melting point, is incorporated as the titanium-containing material, the effects of incorporating TiOF₂ can be obtained up to high temperatures.

The halide solid electrolyte may include a first halide solid electrolyte including a crystalline phase represented by the following composition formula (3):

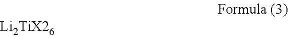

in the composition formula (3), X2 is at least one selected from the group consisting of F, Cl, Br, and I.

The first halide solid electrolyte has a high ionic conductivity of, for example, 1 μS/cm or more and atmospheric stability. Accordingly, owing to the inclusion of the first halide solid electrolyte, the ionic conductivity of the solid electrolyte layer 300 is enhanced. The crystalline phase represented by Li₂TiX2₆ can be identified from a diffraction pattern obtained by micro-X-ray diffraction (XRD) as described above or by powder XRD of a powder sample prepared by scraping the solid electrolyte. Furthermore, the composition of the solid electrolyte can be evaluated, for example, by elemental analysis using an electron probe micro analyzer (EPMA), energy dispersive X-ray spectroscopy (EDS), or the like.

The first halide solid electrolyte may include a crystalline phase represented by the following composition formula (4):

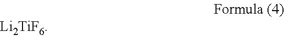

Accordingly, the first halide solid electrolyte has further enhanced atmospheric stability. Therefore, variations in the properties of the solid electrolyte caused by changes in environmental conditions during the manufacturing process can be suppressed, thereby reproducibly obtaining the solid electrolyte layer 300 having the desired properties. Furthermore, strict dew point environment control, temperature control, and humidity control are unnecessary, and therefore manufacturing advantages can also be obtained, such as a reduction in manufacturing cost.

The halide solid electrolyte may further include a second halide solid electrolyte having a composition different from the composition of the first halide solid electrolyte. According to this configuration, the binding property of the solid electrolyte in the solid electrolyte layer 300 can be further enhanced, achieving densification, enhanced strength, and enhanced ionic conductivity of the solid electrolyte layer 300.

The second halide solid electrolyte may have a higher melting point than the first halide solid electrolyte. Because the second halide solid electrolyte has a higher melting point than the first halide solid electrolyte, the second halide solid electrolyte can remain in a harder state than the first halide solid electrolyte at high temperatures. Accordingly, when the solid electrolyte layer 300 that includes the first halide solid electrolyte further includes the second halide solid electrolyte, the hardness of the solid electrolyte layer 300 increases. Consequently, the solid electrolyte layer 300 becomes firm, enhancing flexural resistance and impact resistance, thereby enhancing the reliability of the solid electrolyte layer 300. Therefore, the battery 1000 having enhanced reliability can be achieved.

The second halide solid electrolyte may be harder than the first halide solid electrolyte. Accordingly, when the solid electrolyte layer 300 that includes the first halide solid electrolyte further includes the second halide solid electrolyte, the hardness of the solid electrolyte layer 300 increases. Consequently, the solid electrolyte layer 300 becomes firm, enhancing flexural resistance and impact resistance, thereby enhancing the reliability of the solid electrolyte layer 300. Therefore, the battery 1000 having enhanced reliability can be achieved. The comparison in softness between the second halide solid electrolyte and the first halide solid electrolyte can be evaluated, for example, by a method such as the micro Vickers method.

The second halide solid electrolyte may include a crystalline phase represented by the following composition formula (5):

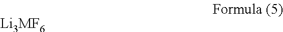

in the composition formula (5), M is at least one element selected from the group consisting of metal elements each having a valence of three and metalloid elements each having a valence of three.

The second halide solid electrolyte including the crystalline phase represented by the composition formula (5) is harder than the first halide solid electrolyte. Accordingly, when the solid electrolyte layer 300 that includes the first halide solid electrolyte further includes the second halide solid electrolyte, the hardness of the solid electrolyte layer 300 increases. Consequently, the solid electrolyte layer 300 becomes firm, enhancing flexural resistance and impact resistance, thereby enhancing the reliability of the solid electrolyte layer 300. Therefore, the battery 1000 having enhanced reliability can be achieved.

In the composition formula (5), M may include Al, and M may be Al. This increases the ionic conductivity of the second halide solid electrolyte to a level comparable to that of the first halide solid electrolyte (e.g., 1 μS/cm or more). Accordingly, the solid electrolyte layer 300 having high ionic conductivity and high reliability can be obtained. Therefore, the battery 1000 having excellent performance and excellent reliability can be achieved. Furthermore, when M is Al, that is, when the second halide solid electrolyte has a composition of Li₃AlF₆, the second halide solid electrolyte can have stability and softness up to relatively high temperatures. Accordingly, by further adding the second halide solid electrolyte having such a configuration to the solid electrolyte layer 300, the solid electrolyte layer 300 can also be densified, further enhancing the ionic conductivity of the solid electrolyte layer 300. Furthermore, since Li₃AlF₆ has excellent heat resistance up to about 700° C. to about 800° C., even when TiOF₂, which has a high melting point, is incorporated as the titanium-containing material, the effects of incorporating TiOF₂ can be obtained up to high temperatures.

The solid electrolyte layer 300, which includes the solid electrolyte, may include, for example, a binder, such as polyethylene oxide or polyvinylidene fluoride.

The solid electrolyte layer 300 may have a thickness of 5 μm or more and 500 μm or less, 10 μm or more and 500 μm or less, or 5 μm or more and 150 μm or less.

The material of the solid electrolyte may be composed of an aggregate of particles. Alternatively, the material of the solid electrolyte may be composed of a sintered structure.

### Titanium-Containing Material

The titanium-containing material included in the battery 1000 according to Embodiment 1 may be in particulate form, such as in the form of the titanium-containing material particles 400. When the titanium-containing material is in particulate form, the titanium-containing material can be incorporated into the respective coating layers on the solid electrolyte particle and the active material particle or incorporated within the solid electrolyte particle. That is, the range of options for the form of the titanium-containing material to be incorporated into the electrode layer and the solid electrolyte layer is broadened. Furthermore, for example, by using finely pulverized particles (e.g., particles having a particle diameter of 1 μm or less) of the titanium-containing material, it is possible to make the solid electrolyte layer 300 thinner or make the coating layers on the active material particles and the like thinner, thereby enhancing the capacity of the battery.

The titanium-containing material particles 400 are, for example, uniformly dispersed within the first electrode layer 100 and within the solid electrolyte layer 300.

The titanium-containing material particles 400 may have an average particle diameter of, for example, 0.3 μm or more and 20 μm or less. In FIG. 1, the titanium-containing material particles 400 are shown as having a spherical particle shape; however, the particles may have a non-spherical particle shape, such as a flake shape.

A smaller particle diameter of the titanium-containing material particles 400 is desirable. Accordingly, the titanium-containing material particles 400 can be uniformly dispersed throughout the first electrode layer 100 and throughout the solid electrolyte layer 300, thereby increasing the surface area of the titanium-containing material particle 400. Consequently, the bonding area between the titanium-containing material particle 400 and the active material or the solid electrolyte, each of which is present around the titanium-containing material particle 400, can be increased. Therefore, the mechanical reliability (flexural resistance) of the first electrode layer 100 and the solid electrolyte layer 300 is further enhanced by reducing the particle diameter of the titanium-containing material particles 400 (e.g., reducing the particle diameter to 1 μm or less).

The titanium-containing material includes, for example, TiOF₂. The titanium-containing material may be TiOF₂. Owing to the inclusion of TiOF₂ in the titanium-containing material, for example, the mechanical bonding property (i.e., the anchoring effect) between the solid electrolyte particles and between the active material particles is enhanced by interposition of hard particles of TiOF₂. For example, when TiOF₂, which is harder than the solid electrolyte, is contained within the solid electrolyte particle, the solid electrolyte particle can be made harder. Furthermore, for example, when TiOF₂ is included in the coating layer on the solid electrolyte particle and/or the active material particle, the TiOF₂ also serves as an anchor that strengthens the bonding between particles. Therefore, a battery having excellent flexural resistance and excellent impact resistance can be obtained. TiOF₂ has excellent heat resistance (e.g., about 1000° C.). Therefore, owing to the inclusion of TiOF₂, excellent reliability of the battery 1000 can be obtained even at high temperatures.

The TiOF₂ may have a cubic crystal structure. Such a crystal system can be obtained by adjusting the heat treatment conditions.

The TiOF₂ having a cubic crystal structure is stable at room temperature and has excellent heat resistance, being stable even at high temperatures of, for example, about 400° C. Furthermore, the TiOF₂ having a cubic crystal structure is hard, and accordingly, also contributes to enhancing the mechanical strength of the battery 1000. Accordingly, by incorporating the TiOF₂ having a cubic crystal structure into the electrode layer and/or the solid electrolyte layer 300, both the heat resistance and mechanical strength of the battery 1000 can be enhanced. Although the TiOF₂ having a cubic crystal structure transitions to a hexagonal crystal system at about 400° C. or higher, the mechanical strength enhancing effect is maintained up to high temperatures because the melting point of TiOF₂ is 1000° C. or higher. In general, an organic binder incorporated into an all-solid-state battery rapidly softens at temperatures equal to or higher than its glass transition point, which is, for example, 100° C. or higher and 250° C. or lower. Accordingly, by incorporating the TiOF₂ having a cubic crystal structure into the electrode layer and/or the solid electrolyte layer 300, a decrease in the mechanical strength of the battery 1000 at high temperatures, for example, exceeding 100° C. can be suppressed.

The crystal structure of the TiO₂ used as the titanium-containing material may be rutile or anatase. Since the phase transition point from anatase to rutile is about 900° C., rutile exhibits the highest high-temperature stability. Accordingly, it is desirable that the crystal structure of the TiO₂ be rutile.

When the titanium-containing material is in particulate form, at least a portion of the surface of the particle of the titanium-containing material may be coated with a coating layer including a solid electrolyte. According to this configuration, the solid electrolyte coating the particle of the titanium-containing material acts as a binder. Accordingly, the bonding property between the particles of the titanium-containing material or between the particle of the titanium-containing material and another type of particle (e.g., the solid electrolyte particle or the active material particle) is enhanced, further enhancing the reliability of the battery. For example, owing to the inclusion of the particles of the titanium-containing material having such a configuration in the solid electrolyte layer, the ionic conductivity of the solid electrolyte layer is also enhanced.

The titanium-containing material may include both TiOF₂ having a cubic crystal structure and TiO₂. Accordingly, the titanium-containing material has excellent bonding property between TiOF₂ and TiO₂ owing to the common element Ti, and at the same time can have further enhanced hardness. Furthermore, by incorporating the titanium-containing material, which includes TiO₂ having high thermal stability together with TiOF₂, into the battery, the binding properties of the solid electrolyte particles and the active material particles at high temperatures can be enhanced. Accordingly, a battery having excellent mechanical strength and excellent heat resistance can be obtained. Owing to such enhancements in strength, deformation of the electrode layer and/or the solid electrolyte layer 300 caused by external impact can be suppressed, thereby suppressing the occurrence of structural defects (delamination and cracking between or within layers). By combining TiOF₂ having a cubic crystal structure, a rutile-type titanium oxide, and an anatase-type titanium oxide in any ratio, the mechanical strength and heat resistance can be adjusted.

The crystal systems of the TiO₂ and the TiOF₂ can be identified, for example, from diffraction patterns obtained by micro-X-ray diffraction (micro-XRD) of respective side surfaces of the electrode layer and the solid electrolyte layer 300 that are exposed on a side surface of the battery 1000. Alternatively, the crystal systems can be confirmed from a lattice image obtained using a high-resolution transmission electron microscope (TEM).

The titanium-containing material may be in particulate form, in a surface region of the particle of the titanium-containing material, the content of the TiOF₂ may be greater than the content of the TiO₂, and in an inner region of the particle of the titanium-containing material, the content of the TiO₂ may be greater than the content of the TiOF₂. According to this configuration, the particle of the titanium-containing material includes a large amount of the TiO₂, which is hard and has heat resistance, in its inner portion, and includes a large amount of the TiOF₂, which has heat resistance, in its surface layer portion. When the particles of such a titanium-containing material are further included in the solid electrolyte layer and/or the electrode layer, each of which includes, for example, halide solid electrolyte particles, the particle of the titanium-containing material can have high bonding property with the halide solid electrolyte particle because both include a halogen element in common. According to this configuration, a power-generating element having high mechanical strength and high heat resistance can be obtained. Therefore, a battery having high reliability can be obtained.

The morphology of composite particles as described above can be evaluated, for example, by SEM observation of an ion-polished cross section of the battery.

When the titanium-containing material is in the form of composite particles as described above, at least a portion of the surface of the particle of the titanium-containing material may be coated with a coating layer including a solid electrolyte. This enhances the bonding property between the titanium-containing material and the solid electrolyte included in the electrolyte layer or in the electrode layer. Therefore, reliability against thermal shock and external stress applied to the solid electrolyte layer and the electrode layer is enhanced.

The titanium-containing material may be in particulate form, and the particles of the titanium-containing material may include: a first particle formed of TiOF₂ having a cubic crystal structure; and a second particle including TiOF₂ having a cubic crystal structure and TiO₂. Accordingly, the heat resistance and mechanical strength of the titanium-containing material can be adjusted depending on the intended application by controlling the mixing ratio between the first particles and the second particles.

The average particle diameter of the second particles may be larger than the average particle diameter of the first particles. Accordingly, while the effect of the second particles in enhancing hardness can be obtained, the first particles, which are softer and have better deformability than the second particles, can reduce voids (gaps between particles) or unevenness that tend to form around the second particles. Consequently, owing to the reduction of voids and unevenness, the electrolyte layer and the electrode layer can have homogenized microstructures, enhancing mechanical strength and impact resistance. Therefore, a battery having high reliability can be obtained.

The content of the titanium-containing material in the solid electrolyte layer 300 may be, for example, 0.01 vol % or more and 5 vol % or less. The content of the titanium-containing material in the first electrode layer 100 may be, for example, 0.01 vol % or more and 3 vol % or less. The content of the titanium-containing material, as described above, can be confirmed by elemental analysis using a high-resolution compositional map obtained using, for example, EPMA of a cross section processed by ion polishing or the like.

The titanium-containing material may be dispersed in the solid electrolyte layer 300 and/or the electrode layer so as to be present between the solid electrolyte particles and/or between the active material particles or in gap portions, and may be included in the solid electrolyte layer 300 and/or the electrode layer in another form.

For example, the titanium-containing material may be included in a coating layer coating at least a portion of the surface of the solid electrolyte particle and/or the active material particle. This enhances the mechanical bonding property (i.e., anchoring effect) between the solid electrolyte particles and/or between the active material particles, enhancing the reliability of the battery 1000 against external stress, thermal cycling, and the like applied to the solid electrolyte layer 300 and/or the electrode layer.

When at least one selected from the group consisting of the first electrode layer 100 and the second electrode layer 200 includes an active material particle and a coating layer coating at least a portion of the surface of the active material particle, this coating layer may include the titanium-containing material. According to this configuration, the binding property and mechanical bonding property (i.e., the anchoring effect) between the active material particles can be enhanced. This enhances the strength of the electrode layer against external stress, thermal cycling, and the like, and thus the occurrence of structural defects such as cracking in the electrode layer can be suppressed. Therefore, the reliability of the battery 1000 can be further enhanced.

When at least one selected from the group consisting of the first electrode layer 100, the second electrode layer 200, and the solid electrolyte layer 300 includes a solid electrolyte particle and a coating layer coating at least a portion of the surface of the solid electrolyte particle, this coating layer may include the titanium-containing material. According to this configuration, the binding property and mechanical bonding property (i.e., the anchoring effect) between the solid electrolyte particles included in the electrode layer and/or the solid electrolyte layer 300, each of which is a power-generating element of the battery 1000, can be enhanced. This enhances the strength of the power-generating element against external stress, thermal cycling, and the like, and therefore the reliability of the battery 1000 can be further enhanced.

At least one selected from the group consisting of the first electrode layer 100, the second electrode layer 200, and the solid electrolyte layer 300 may include a solid electrolyte particle, and the titanium-containing material may be contained within this solid electrolyte particle. For example, the titanium-containing material may be encapsulated within the solid electrolyte particle. In other words, at least a portion of the surface of the particle of the titanium-containing material may be coated with a coating layer including a solid electrolyte. According to this configuration, the interior of the solid electrolyte particle included in the electrode layer and/or the electrolyte layer, each of which is a power-generating element of the battery, can be made harder to enhance strength. Accordingly, the hardness of the solid electrolyte particles can be adjusted depending on the purpose. Furthermore, the surface layer portion of the solid electrolyte particle can be made softer than the interior of the particle, and accordingly, the surface layer portion of the particle can have bonding property and deformability. Accordingly, the bonding property between particles can be enhanced. Owing to the inclusion of such solid electrolyte particles in the power-generating element, the reliability of the power-generating element against external stress, thermal cycling, and the like is enhanced, and therefore the reliability of the battery can be further enhanced. The hardness of the solid electrolyte particles can be adjusted by selecting a halogen element in the titanium oxyhalide included as the titanium-containing material or by incorporating a combination of a plurality of halogen elements. Furthermore, because the titanium-containing material is contained within the solid electrolyte particle, a reduction in ionic conductivity between the solid electrolyte particles caused by the titanium-containing material is suppressed.

The solid electrolyte particle encapsulating the titanium-containing material can be produced, for example, by using, as starting materials for synthesizing the solid electrolyte particles, the titanium-containing material or a raw material including a substance that generates the titanium-containing material as an intermediate, and controlling the synthesis conditions of the solid electrolyte (e.g., heat treatment conditions or conditions of mechanical energy imparted during mechanochemical treatment). That is, the solid electrolyte particle encapsulating the titanium-containing material can be produced by using synthesis conditions under which the titanium-containing material is present within the particle and the synthesized solid electrolyte is present on the particle surface. For example, during heat treatment in the synthesis of the solid electrolyte, setting the heat treatment temperature lower than usual and/or setting the heat treatment time shorter than usual facilitates the production of the solid electrolyte particle encapsulating the titanium-containing material. Furthermore, during mixing and/or dispersion of the starting materials, setting the mixing time shorter than usual and/or setting the dispersion time shorter than usual also facilitates the production of the solid electrolyte particle encapsulating the titanium-containing material. In addition to these methods, it is also possible to produce the solid electrolyte particle encapsulating the titanium-containing material by coating the surface of the titanium-containing material particle with a coating of the solid electrolyte.

The titanium-containing material may be incorporated at the bonding interface between the solid electrolyte layer 300 and the electrode layer. This configuration enhances the bonding property between the solid electrolyte layer 300 and the electrode layer, thereby suppressing delamination that tends to occur due to external impact and thermal cycling.

The inclusion of the titanium-containing material in the battery 1000 can be determined using EPMA, EDS, or X-ray fluorescence analysis (XRF). Furthermore, its morphology and composition can be analyzed by compositional analysis (point analysis or area analysis) using EPMA, EDS, or the like on a polished cross section processed with an ion polisher or the like.

In this manner, by incorporating the titanium-containing material into the solid electrolyte layer 300 and/or the electrode layer, in both of which structural defects tend to occur due to external impact, charge and discharge cycling, and thermal cycling, it is possible to suppress structural defects and deterioration of material properties. Therefore, degradation of the properties of the solid electrolyte layer 300 and/or the electrode layer can be reduced, and the battery 1000 having high reliability can be achieved.

The softness of the titanium-containing material may be adjusted depending on the purpose. For example, a plurality of titanium-containing materials may be used in combination. This enhances the mechanical strength of the battery 1000, enabling suppression of the occurrence of structural defects resulting from external impact, charge and discharge cycling, and thermal cycling.

When the configuration of the battery 1000 according to the present embodiment is compared with the configuration of the battery described in WO 2023/037817, the following differences are observed.

WO 2023/037817 discloses that a solid electrolyte including Li, Ti, M, and F (M=Al, for example) and coating an active material includes a TiO bond and a TiOF bond. However, WO 2023/037817 states that a TiO bond and a TiOF bond are included as bonding states of Ti in the solid electrolyte including Li, Ti, M, and F. Accordingly, WO 2023/037817 does not state that a titanium-containing material is included, as a component, in a solid electrolyte layer or an electrode layer. Thus, the technique described in WO 2023/037817 differs from the technique for the battery according to Embodiment 1 of the present disclosure that enhances the reliability (e.g., mechanical strength or thermal shock resistance) of the solid electrolyte layer and/or the electrode layer.

Furthermore, WO 2023/037817 neither discloses nor suggests enhancing mechanical strength to enhance the reliability of the battery by including a titanium-containing material within the electrode layer and the solid electrolyte layer. In contrast, the battery 1000 according to Embodiment 1 can enhance mechanical strength to enhance the reliability of the battery by including the titanium-containing material.

### Embodiment 2

A battery of Embodiment 2 is described below. The matters described in Embodiment 1 may be omitted as appropriate.

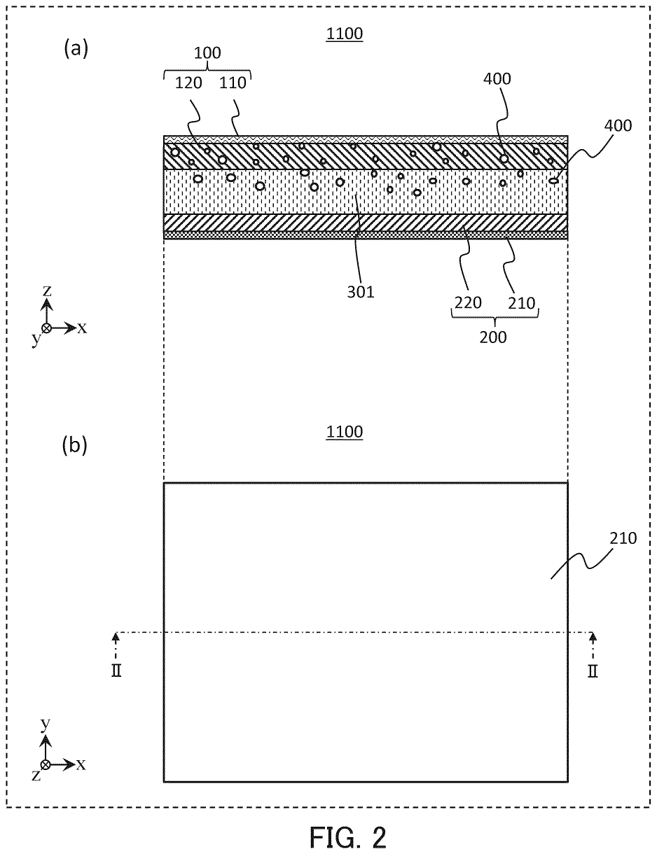

FIG. 2 is a cross-sectional view and a plan view schematically showing the configuration of a battery 1100 according to Embodiment 2.

FIG. 2(a) is a cross-sectional view of the battery 1100 according to Embodiment 2. FIG. 2(b) is a plan view of the battery 1100 according to Embodiment 2 as viewed from below in the z-axis direction. In FIG. 2(a), a cross section at the position indicated by dotted line II-II in FIG. 2(b) is shown.

As shown in FIG. 2, the battery 1100 according to Embodiment 2 is different from the battery 1000 according to Embodiment 1 in the configuration of the solid electrolyte layer.

A solid electrolyte layer 301 in the battery 1100 according to Embodiment 2 differs in that, in the solid electrolyte layer 301, the titanium-containing material particles 400, which are included as the titanium-containing material, are present in a concentrated manner in a region on the side in contact with the first active material layer 120, and are absent in a region on the side in contact with the second active material layer 220. According to such a configuration, the titanium-containing material can be selectively incorporated into a region on the side of the electrode layer that is susceptible to the occurrence of structural defects, for example, the electrode layer including an active material that undergoes significant expansion and contraction during charging and discharging or has a high thermal expansion coefficient. Therefore, the reliability of the battery 1100 can be efficiently enhanced.

An example of a modification of the battery 1100 according to Embodiment 2 is a configuration in which the concentration of the titanium-containing material particles 400 in the region of the solid electrolyte layer 301 on the side in contact with the first active material layer 120 is higher than the concentration of the titanium-containing material particles 400 in the region of the solid electrolyte layer 301 on the side in contact with the second active material layer 220. Even with such a configuration, the reliability of the battery 1100 can be efficiently enhanced.

### Embodiment 3

A battery of Embodiment 3 is described below. The matters described in the above embodiments may be omitted as appropriate.

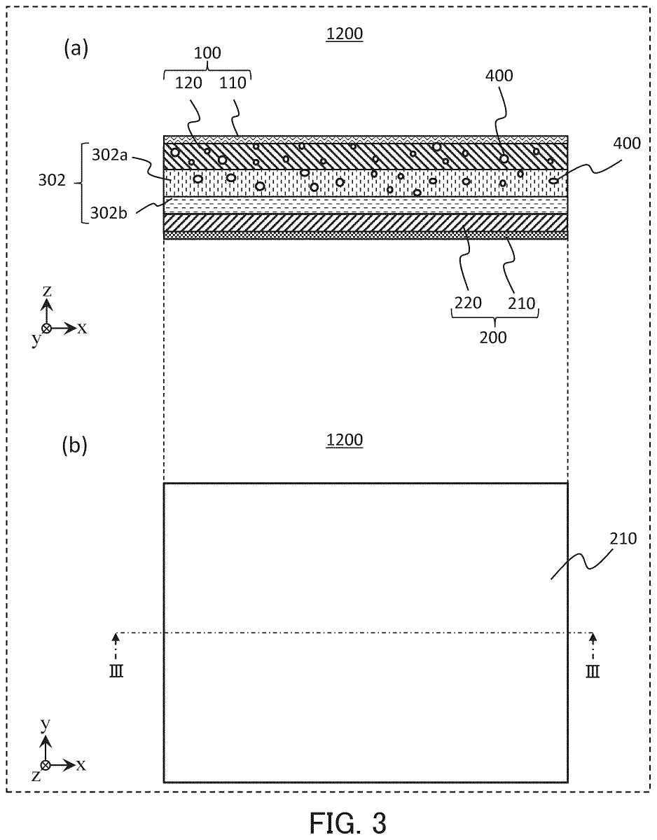

FIG. 3 is a cross-sectional view and a plan view schematically showing the configuration of a battery 1200 according to Embodiment 3.

FIG. 3(a) is a cross-sectional view of the battery 1200 according to Embodiment 3. FIG. 3(b) is a plan view of the battery 1200 according to Embodiment 3 as viewed from below in the z-axis direction. In FIG. 3(a), a cross section at the position indicated by line III-III in FIG. 3(b) is shown.

As shown in FIG. 3, the battery 1200 according to Embodiment 3 differs from the battery 1000 according to Embodiment 1 in the configuration of the solid electrolyte layer.

A solid electrolyte layer 302 in the battery 1200 according to Embodiment 3 includes a first layer 302a in contact with the first electrode layer 100 and a second layer 302b in contact with the second electrode layer 200. The first layer 302a and the second layer 302b include respective solid electrolytes each having a different composition. The first layer 302a includes the titanium-containing material particles 400 as the titanium-containing material. The second layer 302b does not include the titanium-containing material. For example, from the perspective of electrochemical stability and the like, the solid electrolyte material in contact with the first electrode layer 100 and the solid electrolyte material in contact with the second electrode layer 200 may each be formed of a different material. In one example, a configuration may be employed in which a halide solid electrolyte is used as the solid electrolyte material on the positive electrode layer side, and a sulfide solid electrolyte is used as the solid electrolyte material on the negative electrode layer side. When the solid electrolyte layer is composed of a plurality of layers each formed of a different material, as described above, selective incorporation of the titanium-containing material into a layer formed of a material that is susceptible to the occurrence of structural defects enables selective suppression of such defects. Therefore, the reliability of the battery 1200 can be efficiently enhanced.

An example of a modification of the battery 1200 according to Embodiment 3 is a configuration in which both the first layer 302a and the second layer 302b include the titanium-containing material particles 400, and the concentration of the titanium-containing material particles 400 in the first layer 302a is higher than the concentration of the titanium-containing material particles 400 in the second layer 302b. Even with such a configuration, the reliability of the battery 1200 can be efficiently enhanced.

### Embodiment 4

A battery of Embodiment 4 is described below. The matters described in the above embodiments may be omitted as appropriate.

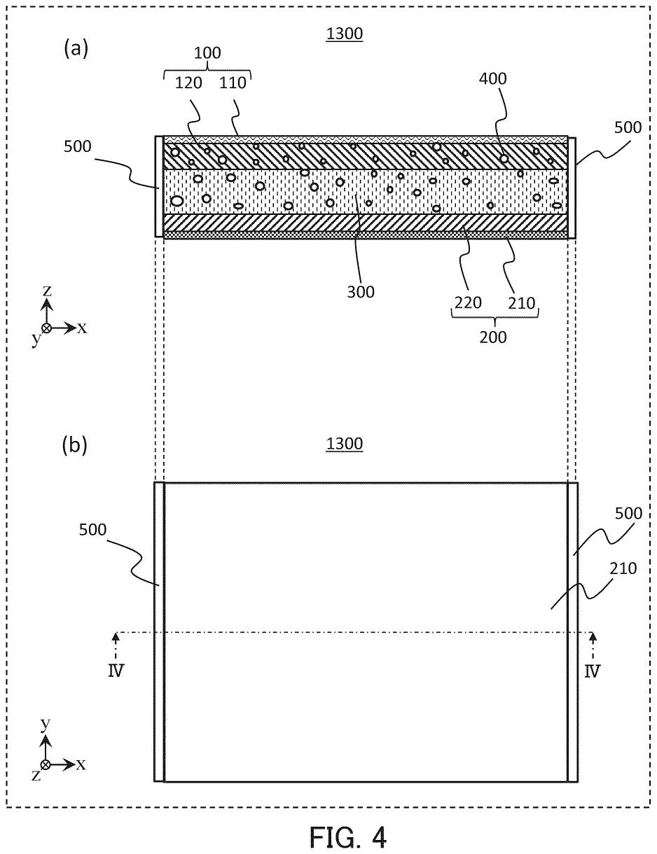

FIG. 4 is a cross-sectional view and a plan view schematically showing the configuration of a battery 1300 according to Embodiment 4.

FIG. 4(a) is a cross-sectional view of the battery 1300 according to Embodiment 4. FIG. 4(b) is a plan view of the battery 1300 according to Embodiment 4 as viewed from below in the z-axis direction. In FIG. 4(a), a cross section at the position indicated by line IV-IV in FIG. 4(b) is shown.

As shown in FIG. 4, the battery 1300 according to Embodiment 4 differs from the battery 1000 according to Embodiment 1 in that the battery 1300 further includes a side surface layer 500, the side surface layer 500 is disposed on a side surface of at least one layer selected from the group consisting of the first electrode layer 100, the second electrode layer 200, and the electrolyte layer 300, and the side surface layer 500 includes the titanium-containing material. That is, the battery 1300 according to Embodiment 4 satisfies the above configuration (II).

According to such a configuration, the battery 1300 according to Embodiment 4 can achieve suppression of external stress applied from the side surface and suppression of the occurrence of structural defects in the side surface portion. Consequently, even higher reliability of the battery 1300 can be achieved.

In the battery 1300 according to Embodiment 4, the side surface layer 500 includes the titanium-containing material. The description of the titanium-containing material included in the side surface layer 500 is the same as the description of the titanium-containing material in Embodiment 1, and accordingly, a detailed description thereof is omitted here.

The side surface layer 500 may include, for example, titanium-containing material particles and an organic binder for binding. The side surface layer 500 can be formed, for example, by applying a paste including the titanium-containing material particles and the organic binder onto a side surface of at least one layer selected from the group consisting of the first electrode layer 100, the second electrode layer 200, and the electrolyte layer 300, and drying the coating film.

The side surface layer 500 may have a thickness of, for example, 1 μm or more and 30 μm or less.

While satisfying the configuration (II), the battery 1300 according to Embodiment 4 also satisfies a configuration in which the titanium-containing material is included in a power-generating element, that is, the above configuration (I); however, the battery 1300 may not satisfy the above configuration (I). That is, the titanium-containing material may be included in none of the power-generating elements.

### Embodiment 5

A battery of Embodiment 5 is described below. The matters described in the above embodiments may be omitted as appropriate.

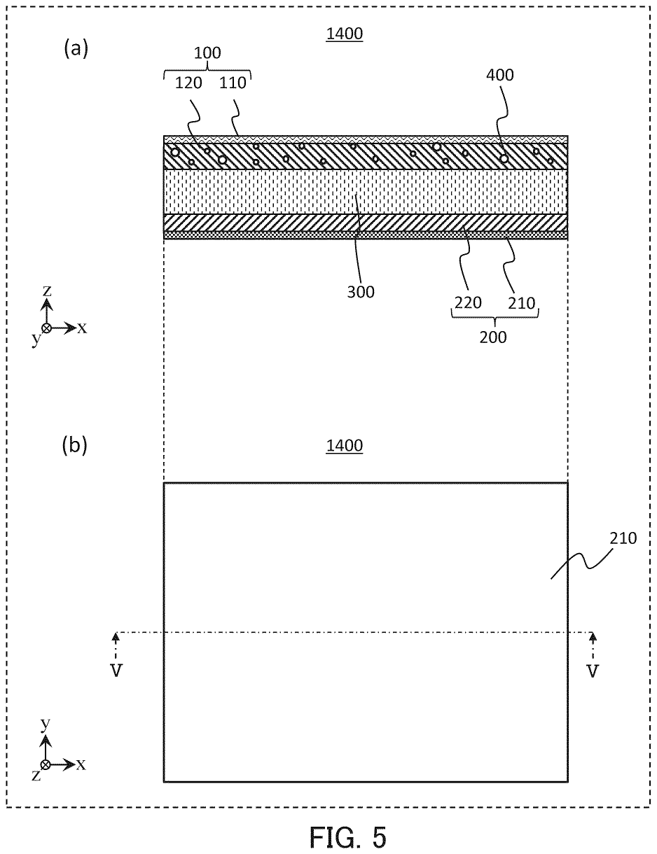

FIG. 5 is a cross-sectional view and a plan view schematically showing the configuration of a battery 1400 according to Embodiment 5.

FIG. 5(a) is a cross-sectional view of the battery 1400 according to Embodiment 5. FIG. 5(b) is a plan view of the battery 1400 according to Embodiment 5 as viewed from below in the z-axis direction. In FIG. 5(a), a cross section at the position indicated by line V-V in FIG. 5(b) is shown.

As shown in FIG. 5, the battery 1400 according to Embodiment 5 differs from the battery 1000 according to Embodiment 1 in that the titanium-containing material particles 400 as the titanium-containing material are included only in the first electrode layer 100.

According to such a configuration, for example, it is possible to suppress an issue in which structural defects tend to occur in a layer (e.g., the electrode layer) that undergoes significant thermal expansion and contraction during charge and discharge cycling and thermal cycling. Consequently, higher reliability of the battery 1400 can be achieved.

### Embodiment 6

A battery of Embodiment 6 is described below. The matters described in the above embodiments may be omitted as appropriate.

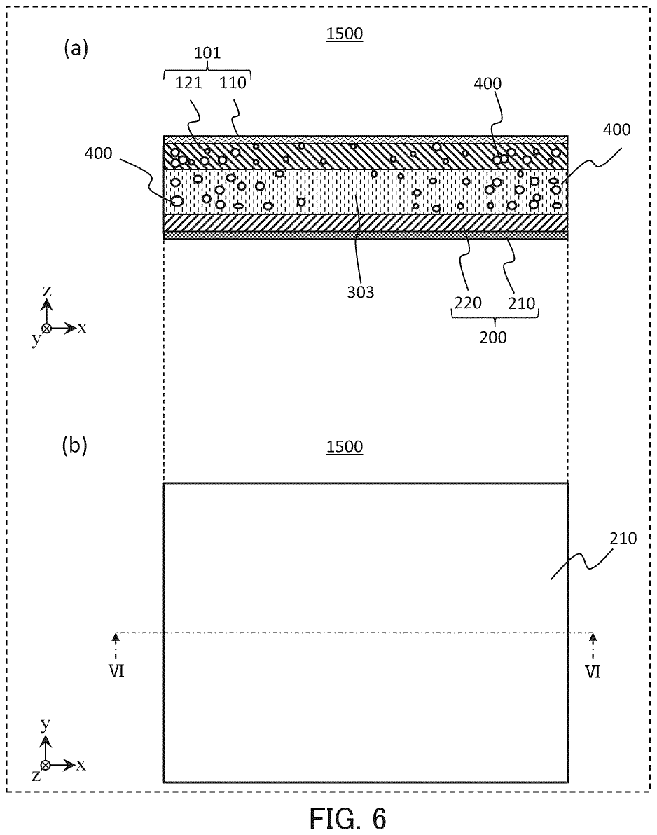

FIG. 6 is a cross-sectional view and a plan view schematically showing the configuration of a battery 1500 according to Embodiment 6.

FIG. 6(a) is a cross-sectional view of the battery 1500 according to Embodiment 6. FIG. 6(b) is a plan view of the battery 1500 according to Embodiment 6 as viewed from below in the z-axis direction. In FIG. 6(a), a cross section at the position indicated by line VI-VI in FIG. 6(b) is shown.

As shown in FIG. 6, the battery 1500 according to Embodiment 6 differs from the battery 1000 according to Embodiment 1 in that the concentration of the titanium-containing material included in the first electrode layer and in the solid electrolyte layer varies within each layer.

In a first electrode layer 101 and a solid electrolyte layer 303, the concentration of the titanium-containing material particles 400 is higher on the outer periphery side (the side closer to the side surface). In the battery 1500 shown in FIG. 6, the concentration of the titanium-containing material particles 400 gradually and continuously varies toward the outer periphery side; however, the configuration may be such that the concentration varies stepwise.

According to such a configuration, the battery 1500 can be such that, in each of the first electrode layer 101 (e.g., a first active material layer 121) and the solid electrolyte layer 303, which are susceptible to damage from external impact (or susceptible to delamination (between or within layers) resulting from charging and discharging and thermal cycling), the outer periphery side is surrounded by a region having an increased concentration of the titanium-containing material particles 400. Accordingly, structural defects in a region on the outer periphery side of a power-generating element, which is susceptible to the occurrence of structural defects, can be effectively suppressed. In plan view, a region having a higher concentration of the titanium-containing material particles 400 may have, for example, a circular or polygonal shape in addition to a rectangular shape, and high reliability can be achieved by shaping the region so as to surround an outer peripheral portion and thus to protect the interior of the battery.

In Embodiments 1 to 6, the battery of the present disclosure has been described taking an all-solid-state battery as an example. However, the battery of the present disclosure is not limited to an all-solid-state battery and may be a liquid battery. That is, in the battery of the present disclosure, the electrolyte layer may be composed, for example, of an electrolyte solution and a separator impregnated with the electrolyte solution. Even in the case of a liquid battery, a battery having high reliability can be achieved by including the titanium-containing material in a manner similar to that in the all-solid-state batteries described in Embodiments 1 to 6.

In the case of a liquid battery, at least one selected from the group consisting of the first electrode layer and the second electrode layer includes the titanium-containing material. In this case, the titanium-containing material is included, for example, in a coating layer coating at least a portion of the surface of the active material particle. This coating layer may include, for example, a solid electrolyte and the titanium-containing material.

### Method for Manufacturing Battery

Next, an example of a method for manufacturing the battery according to the present embodiment is described. The following describes a method for manufacturing the battery 1000 according to Embodiment 1 described above.

The following describes an example in which the first electrode layer 100 is the positive electrode layer and the second electrode layer 200 is the negative electrode layer. That is, in the following description, the first active material layer 120 is the positive electrode active material layer, the first current collector 110 is the positive electrode current collector, the second active material layer 220 is the negative electrode active material layer, and the second current collector 210 is the negative electrode current collector.

First, pastes to be used for forming the positive electrode active material layer and the negative electrode active material layer by printing are prepared. The solid electrolyte prepared for use in respective mixtures for the positive electrode active material layer and the negative electrode active material layer is, for example, a solid electrolyte powder (Li₃AlF₆—Li₂TiF₆) having an average particle diameter of about 3 μm and including a halide as its main component. As this powder, for example, a powder having high ionic conductivity (e.g., 1×10⁻³ S/cm to 3×10⁻³ S/cm) is used.

As the positive electrode active material, for example, a Li·Ni·Co·Al composite oxide powder (LiNi_{0.8}Co_{0.15}Al_{0.05}O₂) having an average particle diameter of about 5 μm and a layered structure is used. Furthermore, as the titanium-containing material, a TiOF₂ powder having an average particle diameter of about 1 μm is prepared.

A positive electrode active material layer paste, in which a mixture obtained by incorporating the above positive electrode active material, the above solid electrolyte powder, and the TiOF₂ powder is dispersed in an organic solvent or the like, is prepared using a three-roll mill.

As the negative electrode active material, for example, a natural graphite powder having an average particle diameter of about 10 μm is used. A negative electrode active material layer paste, in which a mixture obtained by incorporating the above negative electrode active material and the above solid electrolyte powder is dispersed in an organic solvent or the like, is prepared in the same manner as the positive electrode active material layer paste.

Subsequently, as a material for use in the positive electrode current collector and the negative electrode current collector, for example, a copper foil having a thickness of about 30 μm is prepared. The positive electrode active material layer paste and the negative electrode active material layer paste are each printed on one surface of the corresponding copper foil by a screen printing method to have a predetermined shape and a thickness of about 50 μm to about 100 μm. The positive electrode active material layer paste and the negative electrode active material layer paste are dried at 80° C. to 130° C. to have a thickness of 30 μm to 60 μm. The positive electrode active material layer paste includes the TiOF₂ powder. Thus, respective current collectors (copper foils) are obtained on which the positive electrode active material layer and the negative electrode active material layer are formed.

Subsequently, a solid electrolyte layer paste dispersed in an organic solvent or the like is prepared with the incorporation of the TiOF₂ powder. On the principal surface of the positive electrode active material layer formed on the positive electrode current collector, the above solid electrolyte layer paste including the TiOF₂ powder is printed using a metal mask to have a thickness of, for example, about 100 μm. On the principal surface of the negative electrode active material layer formed on the negative electrode current collector, the above solid electrolyte layer paste including the TiOF₂ powder is printed using a metal mask to have a thickness of, for example, about 100 μm. Thereafter, the positive electrode active material layer and the negative electrode active material layer, on which the solid electrolyte layer pastes are printed on their principal surfaces, are dried at 80° C. to 130° C.

Subsequently, these electrode structures are stacked so that the solid electrolyte printed on the positive electrode active material layer formed on the positive electrode current collector and the solid electrolyte printed on the negative electrode active material layer formed on the negative electrode current collector are in contact with and face each other. The resulting stack is placed in a die having a rectangular outer shape.

Subsequently, an elastic sheet having, for example, a thickness of about 50 μm to about 100 μm and an elastic modulus of about 5×10⁶ Pa is inserted between a press die and the above stack. According to this configuration, a pressure is applied to the stack through the elastic sheet. Thereafter, the stack is pressed, for example, for 90 seconds while the press die is heated to 50° C. to 80° C. under a pressure of 300 MPa to 350 MPa. Thus, a battery including a positive electrode layer, a negative electrode layer, and an electrolyte layer disposed between the positive electrode layer and the negative electrode layer is obtained.

The battery manufacturing method is not limited to the above example.

In the above manufacturing method, an example is presented in which the positive electrode active material layer paste, the negative electrode active material layer paste, and the solid electrolyte layer paste are applied by printing; however, printing is not limited to this. The printing method may be, for example, a doctor blade method, a calendering method, a spin coating method, a dip coating method, an inkjet method, an offset method, a die coating method, or a spray method.

### Other Embodiments

### Supplementary Description

The above description of the embodiments discloses the following techniques.

### Technique 1

A battery including:
a first electrode layer;
a second electrode layer; and
an electrolyte layer disposed between the first electrode layer and the second electrode layer, wherein
the battery satisfies at least one configuration selected from the group consisting of the following (I) and (II):
   (I) at least one selected from the group consisting of the first electrode layer, the second electrode layer, and the electrolyte layer includes at least one titanium-containing material selected from the group consisting of a titanium oxyhalide and a titanium oxide; and
   (II) the battery further includes a side surface layer, the side surface layer being disposed on a side surface of at least one layer selected from the group consisting of the first electrode layer, the second electrode layer, and the electrolyte layer, the side surface layer including at least one titanium-containing material selected from the group consisting of a titanium oxyhalide and a titanium oxide,
the titanium oxyhalide is represented by the following composition formula (1):

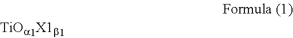

in the composition formula (1), the X1 is at least one selected from the group consisting of F, Cl, Br, and I, the α1 satisfies 0.95≤α1≤1.05, and the β1 satisfies 1.95≤β1≤2.05, and
the titanium oxide is represented by the following composition formula (2):

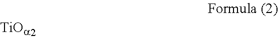

in the composition formula (2), the α2 satisfies 1.95≤α2≤2.05.

The above titanium-containing material is relatively hard, and is harder than, for example, the solid electrolyte included in the battery. Accordingly, the battery according to Technique 1 including the above titanium-containing material has enhanced mechanical strength, enhancing flexural resistance and impact resistance. Therefore, the battery according to Technique 1 can have enhanced mechanical strength and thus enhanced reliability. The amount and location of the above titanium-containing material to be included may be adjusted as appropriate depending on the purpose. Therefore, the battery according to Technique 1 can obtain desired reliability.

The above effects can be achieved by any of the above configurations (I) and (II). For example, when the above configuration (I) is satisfied, it is possible to enhance the strength of the electrode layer and/or the electrolyte layer, each of which is a power-generating element of the battery. This enhances the reliability of the battery. Furthermore, when the above configuration (II) is satisfied, it is possible to effectively suppress, by the side surface layer including the titanium-containing material, structural defects that tend to occur at a side surface of the battery serving as an initiation site (i.e., cracking or peeling originating from a side surface) and in which the influence of external impact and thermal shock tends to become apparent. This enhances the reliability of the battery.

### Technique 2

The battery according to Technique 1, wherein
the electrolyte layer is a solid electrolyte layer.

According to this configuration, an all-solid-state battery having enhanced reliability can be provided.

### Technique 3

The battery according to Technique 2, wherein
the solid electrolyte layer includes a halide solid electrolyte.

According to this configuration, a battery having higher reliability can be obtained. For example, when the titanium oxyhalide is included as the titanium-containing material, the halide solid electrolyte included in the solid electrolyte layer and the titanium oxyhalide have thermal expansion characteristics that tend to match each other because both are halides. Accordingly, the bonding interface between the titanium oxyhalide and the halide solid electrolyte becomes firm. This suppresses the occurrence of structural defects caused by peeling at the bonding interface between the titanium oxyhalide and the halide solid electrolyte that results from thermal shock or thermal cycling. That is, when the titanium oxyhalide is included as the titanium-containing material, the effectiveness of the titanium-containing material against thermal shock and thermal cycling is even further enhanced. Therefore, a battery having higher reliability can be obtained.

### Technique 4

The battery according to Technique 1, wherein
the electrolyte layer is composed of an electrolyte solution and a separator impregnated with the electrolyte solution.

According to this configuration, a liquid battery having enhanced reliability can be provided.

### Technique 5

The battery according to any one of Techniques 1 to 4, wherein
the battery satisfies the (I),
at least one selected from the group consisting of the first electrode layer, the second electrode layer, and the electrolyte layer includes a solid electrolyte particle and a coating layer coating at least a portion of a surface of the solid electrolyte particle, and
the coating layer includes the titanium-containing material.

According to this configuration, the binding property and mechanical bonding property (i.e., the anchoring effect) between the solid electrolyte particles included in the electrode layer and/or the electrolyte layer, each of which is a power-generating element of the battery, can be enhanced. This enhances the strength of the power-generating element against external stress, thermal cycling, and the like, and therefore the reliability of the battery can be further enhanced.

### Technique 6

The battery according to any one of Techniques 1 to 4, wherein
the battery satisfies the (I),
at least one selected from the group consisting of the first electrode layer, the second electrode layer, and the electrolyte layer includes a solid electrolyte particle, and
the titanium-containing material is contained within the solid electrolyte particle.

According to this configuration, the interior of the solid electrolyte particle included in the electrode layer and/or the electrolyte layer, each of which is a power-generating element of the battery, can be made harder to enhance strength. Accordingly, the hardness of the solid electrolyte particles can be adjusted depending on the purpose. Furthermore, the surface layer portion of the solid electrolyte particle can be made softer than the interior of the particle, and accordingly, the surface layer portion of the particle can have bonding property and deformability. Accordingly, the bonding property between particles can be enhanced. Owing to the inclusion of such solid electrolyte particles in the power-generating element, the reliability of the power-generating element against external stress, thermal cycling, and the like is enhanced, and therefore the reliability of the battery can be further enhanced. The hardness of the solid electrolyte particles can be adjusted by selecting a halogen element in the titanium oxyhalide included as the titanium-containing material or by incorporating a combination of a plurality of halogen elements. Furthermore, because the titanium-containing material is contained within the solid electrolyte particle, a reduction in ionic conductivity between the solid electrolyte particles caused by the titanium-containing material is suppressed.

### Technique 7

The battery according to any one of Techniques 1 to 6, wherein
the battery satisfies the (I),
at least one selected from the group consisting of the first electrode layer and the second electrode layer includes an active material particle and a coating layer coating at least a portion of a surface of the active material particle, and
the coating layer includes the titanium-containing material.

According to this configuration, the mechanical bonding property (i.e., the anchoring effect) between the active material particles can be enhanced. This enhances the strength of the electrode layer against external stress, thermal cycling, and the like, and thus the occurrence of structural defects such as cracking in the electrode layer can be suppressed. Therefore, the reliability of the battery can be further enhanced.

### Technique 8

The battery according to any one of Techniques 1 to 7, wherein
the titanium-containing material is in particulate form.

This configuration facilitates incorporation of the titanium-containing material into the respective coating layers on the solid electrolyte particle and the active material particle, or incorporation of the titanium-containing material within the solid electrolyte particle. Furthermore, for example, by using finely pulverized particles of the titanium-containing material, it is possible to make the electrolyte layer thinner or make the coating layers on the active material particles and the like thinner, thereby enhancing the capacity of the battery.

### Technique 9

The battery according to any one of Techniques 1 to 8, wherein
the titanium-containing material includes TiOF₂.

According to this configuration, for example, the mechanical bonding property (i.e., the anchoring effect) between the solid electrolyte particles and between the active material particles is enhanced by interposition of hard particles of TiOF₂. For example, when TiOF₂, which is harder than the solid electrolyte, is contained within the solid electrolyte particle, the solid electrolyte particle can be made harder. Furthermore, for example, when TiOF₂ is included in the coating layer on the solid electrolyte particle and/or the active material particle, the TiOF₂ also serves as an anchor that strengthens the bonding between particles. Therefore, a battery having excellent flexural resistance and excellent impact resistance can be obtained. TiOF₂ has excellent heat resistance (e.g., about 1000° C.). Therefore, excellent reliability can be obtained even at high temperatures.

### Technique 10

The battery according to Technique 9, wherein
the TiOF₂ has a cubic crystal structure.

Accordingly, it is possible to obtain highly heat-resistant TiOF₂ that is stable even at high temperatures of, for example, about 400° C. Accordingly, TiOF₂ having excellent mechanical strength and excellent heat resistance can be incorporated into the battery, and therefore a battery having further excellent reliability can be obtained. The crystal system of the TiOF₂ can be identified, for example, from a diffraction pattern obtained by micro-XRD of a surface exposed on a side surface of the battery. Alternatively, the crystal system can be confirmed from a lattice image obtained using a high-resolution TEM.

### Technique 11

The battery according to Technique 10, wherein
the titanium-containing material is in particulate form, and
at least a portion of a surface of a particle of the titanium-containing material is coated with a coating layer including a solid electrolyte.

According to this configuration, the solid electrolyte coating the particle of the titanium-containing material acts as a binder. Accordingly, the bonding property between the particles of the titanium-containing material or between the particle of the titanium-containing material and another type of particle (e.g., the solid electrolyte particle or the active material particle) is enhanced, further enhancing the reliability of the battery.

### Technique 12

The battery according to any one of Techniques 1 to 11, wherein
the titanium-containing material includes TiOF₂ having a cubic crystal structure and TiO₂.

Accordingly, the titanium-containing material has excellent bonding property between TiOF₂ and TiO₂ owing to the common element Ti, and at the same time can have further enhanced hardness. Furthermore, by incorporating the titanium-containing material, which includes TiO₂ having high thermal stability together with TiOF₂, into the battery, the binding properties of the solid electrolyte particles and the active material particles at high temperatures can be enhanced. Accordingly, a battery having excellent mechanical strength and excellent heat resistance can be obtained.

### Technique 13

The battery according to Technique 12, wherein
the titanium-containing material is in particulate form,
in a surface region of a particle of the titanium-containing material, a content of the TiOF₂ is greater than a content of the TiO₂, and
in an inner region of the particle of the titanium-containing material, the content of the TiO₂ is greater than the content of the TiOF₂.

According to this configuration, the particle of the titanium-containing material includes a large amount of the TiO₂, which is hard and has heat resistance, in its inner portion, and includes a large amount of the TiOF₂, which has heat resistance, in its surface layer portion. When the particles of such a titanium-containing material are further included in the solid electrolyte layer and/or the electrode layer, each of which includes, for example, halide solid electrolyte particles, the particle of the titanium-containing material can have high bonding property with the halide solid electrolyte particle because both include a halogen element in common. According to this configuration, a power-generating element having high mechanical strength and high heat resistance can be obtained. Therefore, a battery having high reliability can be obtained.

### Technique 14

The battery according to Technique 13, wherein
at least a portion of a surface of a particle of the titanium-containing material is coated with a coating layer including a solid electrolyte.

This enhances the bonding property between the titanium-containing material and the solid electrolyte included in the electrolyte layer or in the electrode layer. Therefore, reliability against thermal shock and external stress applied to the solid electrolyte layer and the electrode layer is enhanced.

### Technique 15

The battery according to Technique 9, wherein
the titanium-containing material is in particulate form, and
particles of the titanium-containing material include:
   a first particle formed of TiOF₂ having a cubic crystal structure; and
   a second particle including TiOF₂ having a cubic crystal structure and TiO₂.

Accordingly, the heat resistance and mechanical strength of the titanium-containing material can be adjusted depending on the intended application by controlling the mixing ratio between the first particles and the second particles.

### Technique 16

The battery according to Technique 15, wherein
an average particle diameter of the second particles is larger than an average particle diameter of the first particles.

Accordingly, while the effect of the second particles in enhancing hardness can be obtained, the first particles, which are softer and have better deformability than the second particles, can reduce voids (gaps between particles) or unevenness that tend to form around the second particles. Consequently, owing to the reduction of voids and unevenness, the electrolyte layer and the electrode layer can have homogenized microstructures, enhancing mechanical strength and impact resistance. Therefore, a battery having high reliability can be obtained.

### Technique 17

The battery according to Technique 3, wherein
the halide solid electrolyte includes Ti.

According to this configuration, a solid electrolyte layer including a solid electrolyte having a high ionic conductivity of, for example, 1 μS/cm or more, can be obtained. Furthermore, owing to the presence of Ti, which is included in both the titanium-containing material and the halide solid electrolyte in common, the titanium-containing material and the solid electrolyte firmly bond to each other, facilitating formation of an integrated bonding interface. Accordingly, when the titanium-containing material is included in the solid electrolyte layer, the titanium-containing material can coexist with the solid electrolyte within the solid electrolyte layer, in a stable manner (e.g., with no formation of fine defects in the surrounding region). Therefore, a battery having further enhanced reliability can be obtained.

### Technique 18

The battery according to Technique 17, wherein
the halide solid electrolyte includes a first halide solid electrolyte including a crystalline phase represented by the following composition formula (3):

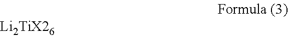

in the composition formula (3), the X2 is at least one selected from the group consisting of F, Cl, Br, and I.

According to this configuration, the solid electrolyte layer includes a solid electrolyte having a high ionic conductivity of, for example, 1 μS/cm or more, thereby enhancing the ionic conductivity of the solid electrolyte layer. The crystalline phase represented by Li₂TiX2₆ can be identified from a diffraction pattern obtained by micro-XRD as described above or by powder XRD of a powder sample prepared by scraping the solid electrolyte. Furthermore, the composition of the solid electrolyte can be evaluated, for example, by elemental analysis using EPMA, EDS, or the like.

### Technique 19

The battery according to Technique 18, wherein
the first halide solid electrolyte includes a crystalline phase represented by the following composition formula (4):

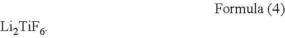

Accordingly, the first halide solid electrolyte has further enhanced atmospheric stability. Therefore, variations in the properties of the solid electrolyte caused by changes in environmental conditions during the manufacturing process can be suppressed, thereby reproducibly obtaining the solid electrolyte layer having the desired properties. Furthermore, strict dew point environment control, temperature control, and humidity control are unnecessary, and therefore manufacturing advantages can also be obtained, such as a reduction in manufacturing cost.

### Technique 20

The battery according to Technique 18 or 19, wherein
the halide solid electrolyte further includes a second halide solid electrolyte having a composition different from a composition of the first halide solid electrolyte.

According to this configuration, the binding property of the solid electrolyte in the solid electrolyte layer can be further enhanced, achieving densification, enhanced strength, and enhanced ionic conductivity of the solid electrolyte layer.

### Technique 21

The battery according to Technique 20, wherein
the second halide solid electrolyte has a higher melting point than the first halide solid electrolyte.

Because the second halide solid electrolyte has a higher melting point than the first halide solid electrolyte, the second halide solid electrolyte can remain in a harder state than the first halide solid electrolyte at high temperatures. Accordingly, when the solid electrolyte layer that includes the first halide solid electrolyte further includes the second halide solid electrolyte, the hardness of the solid electrolyte layer increases. Consequently, the solid electrolyte layer becomes firm, enhancing flexural resistance and impact resistance, thereby enhancing the reliability of the solid electrolyte layer. Therefore, a battery having enhanced reliability can be achieved.

### Technique 22

The battery according to Technique 20 or 21, wherein
the second halide solid electrolyte is harder than the first halide solid electrolyte.

Accordingly, when the solid electrolyte layer that includes the first halide solid electrolyte further includes the second halide solid electrolyte, the hardness of the solid electrolyte layer increases. Consequently, the solid electrolyte layer becomes firm, enhancing flexural resistance and impact resistance, thereby enhancing the reliability of the solid electrolyte layer. Therefore, a battery having enhanced reliability can be achieved.

### Technique 23

The battery according to any one of Techniques 20 to 22, wherein
the second halide solid electrolyte includes a crystalline phase represented by the following composition formula (5):

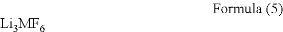

in the composition formula (5), the M is at least one element selected from the group consisting of metal elements each having a valence of three and metalloid elements each having a valence of three.

Accordingly, the second halide solid electrolyte, which is harder than the first halide solid electrolyte, can be used. Accordingly, when the solid electrolyte layer that includes the first halide solid electrolyte further includes the second halide solid electrolyte, the hardness of the solid electrolyte layer increases. Consequently, the solid electrolyte layer becomes firm, enhancing flexural resistance and impact resistance, thereby enhancing the reliability of the solid electrolyte layer. Therefore, a battery having enhanced reliability can be achieved.

### Technique 24

The battery according to Technique 23, wherein
the M includes Al.

This increases the ionic conductivity of the second halide solid electrolyte to a level comparable to that of the first halide solid electrolyte (e.g., 1 μS/cm or more). Accordingly, a solid electrolyte layer having high ionic conductivity and high reliability can be obtained. Therefore, a battery having excellent performance and excellent reliability can be obtained.

The battery according to the present disclosure has been described based on the embodiments; however, the present disclosure is not limited to these embodiments. Various modifications of the embodiments conceivable by those skilled in the art and other embodiments achieved by combining some of the constituents of the embodiments also fall within the scope of the present disclosure without departing from the spirit of the present disclosure.

Furthermore, the above embodiments may undergo various modifications, replacements, additions, omissions, and the like within the scope of the claims or equivalents thereof.

### Industrial Applicability

The battery according to the present disclosure can be used, for example, as a secondary battery such as an all-solid-state battery or a liquid battery for use in various electronic devices, automobiles, and the like.

What is claimed is:

1. A battery comprising:
a first electrode layer;
a second electrode layer; and
an electrolyte layer disposed between the first electrode layer and the second electrode layer, wherein
the battery satisfies at least one configuration selected from the group consisting of the following (I) and (II):
(I) at least one selected from the group consisting of the first electrode layer, the second electrode layer, and the electrolyte layer comprises at least one titanium-containing material selected from the group consisting of a titanium oxyhalide and a titanium oxide; and
(II) the battery further comprises a side surface layer, the side surface layer being disposed on a side surface of at least one layer selected from the group consisting of the first electrode layer, the second electrode layer, and the electrolyte layer, the side surface layer comprising at least one titanium-containing material selected from the group consisting of a titanium oxyhalide and a titanium oxide,
the titanium oxyhalide is represented by the following composition formula (1): 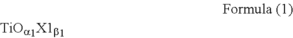
in the composition formula (1), the X1 is at least one selected from the group consisting of F, Cl, Br, and I, the α1 satisfies 0.95≤α1≤1.05, and the β1 satisfies 1.95≤β1≤2.05, and
the titanium oxide is represented by the following composition formula (2): 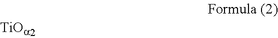
in the composition formula (2), the α2 satisfies 1.95≤α2≤2.05.

2. The battery according to claim 1, wherein
the electrolyte layer is a solid electrolyte layer.

3. The battery according to claim 2, wherein
the solid electrolyte layer comprises a halide solid electrolyte.

4. The battery according to claim 1, wherein
the electrolyte layer is composed of an electrolyte solution and a separator impregnated with the electrolyte solution.

5. The battery according to claim 1, wherein
the battery satisfies the (I),
at least one selected from the group consisting of the first electrode layer, the second electrode layer, and the electrolyte layer comprises a solid electrolyte particle and a coating layer coating at least a portion of a surface of the solid electrolyte particle, and
the coating layer comprises the titanium-containing material.

6. The battery according to claim 1, wherein
the battery satisfies the (I),
at least one selected from the group consisting of the first electrode layer, the second electrode layer, and the electrolyte layer comprises a solid electrolyte particle, and
the titanium-containing material is contained within the solid electrolyte particle.

7. The battery according to claim 1, wherein
the battery satisfies the (I),
at least one selected from the group consisting of the first electrode layer and the second electrode layer comprises an active material particle and a coating layer coating at least a portion of a surface of the active material particle, and
the coating layer comprises the titanium-containing material.

8. The battery according to claim 1, wherein
the titanium-containing material is in particulate form.

9. The battery according to claim 1, wherein
the titanium-containing material comprises TiOF₂.

10. The battery according to claim 9, wherein
the TiOF₂ has a cubic crystal structure.

11. The battery according to claim 10, wherein
the titanium-containing material is in particulate form, and
at least a portion of a surface of a particle of the titanium-containing material is coated with a coating layer comprising a solid electrolyte.

12. The battery according to claim 1, wherein
the titanium-containing material comprises TiOF₂ having a cubic crystal structure and TiO₂.

13. The battery according to claim 12, wherein
the titanium-containing material is in particulate form,
in a surface region of a particle of the titanium-containing material, a content of the TiOF₂ is greater than a content of the TiO₂, and
in an inner region of the particle of the titanium-containing material, the content of the TiO₂ is greater than the content of the TiOF₂.

14. The battery according to claim 13, wherein
at least a portion of a surface of a particle of the titanium-containing material is coated with a coating layer comprising a solid electrolyte.

15. The battery according to claim 9, wherein
the titanium-containing material is in particulate form, and
particles of the titanium-containing material comprise:
a first particle formed of TiOF₂ having a cubic crystal structure; and
a second particle comprising TiOF₂ having a cubic crystal structure and TiO₂.

16. The battery according to claim 15, wherein
an average particle diameter of the second particles is larger than an average particle diameter of the first particles.

17. The battery according to claim 3, wherein
the halide solid electrolyte comprises Ti.

18. The battery according to claim 17, wherein
the halide solid electrolyte comprises a first halide solid electrolyte comprising a crystalline phase represented by the following composition formula (3): 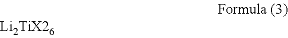
in the composition formula (3), the X2 is at least one selected from the group consisting of F, Cl, Br, and I.

19. The battery according to claim 18, wherein
the first halide solid electrolyte comprises a crystalline phase represented by the following composition formula (4):

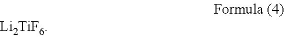

20. The battery according to claim 18, wherein
the halide solid electrolyte further comprises a second halide solid electrolyte having a composition different from a composition of the first halide solid electrolyte.
